(19) United States
(12) Patent Application Publication
(10) Pub. No.: US 2026/0217453 A1
(43) Pub. Date: Jul. 30, 2026

(54) AUTOMATIC TRANSPORT SYSTEM

(71) Applicant: Sharp Kabushiki Kaisha, Sakai City (JP)

(72) Inventors: Kyosuke TAKA, Sakai City (JP); Naoto YOSHINAGA, Sakai City (JP); Yuuki MATSUOKA, Sakai City (JP)

(21) Appl. No.: 19/444,390

(22) Filed: Jan. 9, 2026

(30) Foreign Application Priority Data
Jan. 29, 2025 (JP) 2025-012725

(51) Int. Cl. B65G 1/02; B65G 1/04

(52) U.S. Cl. CPC B65G 1/026; B65G 1/0471; B65G 1/0492

(57) ABSTRACT

A storage shelf includes a stock shelf that stores a transport object, and a transfer device that takes in and out the transport object on the stock shelf. An automatic transport device includes a coupler couplable to the storage shelf and switchable between a coupled state being coupled to the storage shelf and a non-coupled state not being coupled to the storage shelf, an electric power supplier that supplies electric power to the transfer device via the coupler when the coupler is in the coupled state, and a traveler that causes the automatic transport device to travel.

### INCORPORATION BY REFERENCE

This application is based upon and claims the benefit of priority from the corresponding Japanese Patent Application No. 2025-012725 filed on Jan. 29, 2025, the entire contents of which are incorporated herein by reference.

### BACKGROUND

The present disclosure relates to an automatic transport system that transports a transport object.

In the related art, in a warehouse or the like, there is known an automatic transport device that takes out an article to be transported (a transport object) from a storage shelf and transports the article to a target place (outbound location or the like). For example, when receiving a delivery command, the automatic transport device moves to a predetermined storage shelf along a guide line, loads an article on the storage shelf, and then, moves to a target place (station). Further, work of taking out the transport object from the storage shelf is performed by a picking head provided in the storage shelf.

In a conventional warehouse or the like, a storage shelf provided with a picking head is fixed at a predetermined position. For this reason, the conventional automatic transport device is configured to move to a fixed storage shelf to receive an article, or transport an article to a fixed storage shelf. Further, in order to take in and out the article from the storage shelf, the automatic transport device must be moved to the fixed storage shelf, which makes it difficult to perform a flexible operation.

### SUMMARY

An object of the present disclosure is to provide an automatic transport system that enables to perform a flexible operation in a system for transporting a transport object by an automatic transport device.

An automatic transport system according to an aspect of the present disclosure includes a storage shelf, and an automatic transport device capable of transporting the storage shelf in a state of being coupled to the storage shelf. The storage shelf includes a storage that stores a transport object, and a driver that takes in and out the transport object in the storage. The automatic transport device includes a coupler couplable to the storage shelf and switchable between a coupled state in which the coupler is coupled to the storage shelf and a non-coupled state in which the coupler is not coupled to the storage shelf, an electric power supplier that supplies electric power to the driver via the coupler when the coupler is in the coupled state, and a traveler that causes the automatic transport device to travel.

According to the present disclosure, it is possible to provide an automatic transport system that enables to perform a flexible operation in a system for transporting a transport object by an automatic transport device.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a side view illustrating an overall configuration of an automatic transport system according to an embodiment of the present disclosure.

FIG. 2 is a side view illustrating an overall configuration of an automatic transport device and a storage shelf according to the embodiment of the present disclosure.

FIG. 3 is a front view illustrating an overall configuration of the automatic transport system according to the embodiment of the present disclosure.

FIG. 4 is a diagram illustrating the automatic transport system and the storage shelf according to the embodiment of the present disclosure.

FIGS. 5A to 5D are diagrams illustrating an example of a picking method performed in the storage shelf according to the embodiment of the present disclosure.

FIG. 6 is a side view illustrating a configuration of the automatic transport device according to the embodiment of the present disclosure.

FIG. 7 is a diagram illustrating a method of coupling the automatic transport device and the storage shelf according to the embodiment of the present disclosure.

FIG. 8 is a diagram illustrating the method of coupling the automatic transport device and the storage shelf according to the embodiment of the present disclosure.

### DETAILED DESCRIPTION

Hereinafter, an embodiment of the present disclosure is described with reference to the accompanying drawings for understanding of the present disclosure. Note that, the following embodiment is an example in which the present disclosure is embodied, and does not limit the technical scope of the present disclosure.

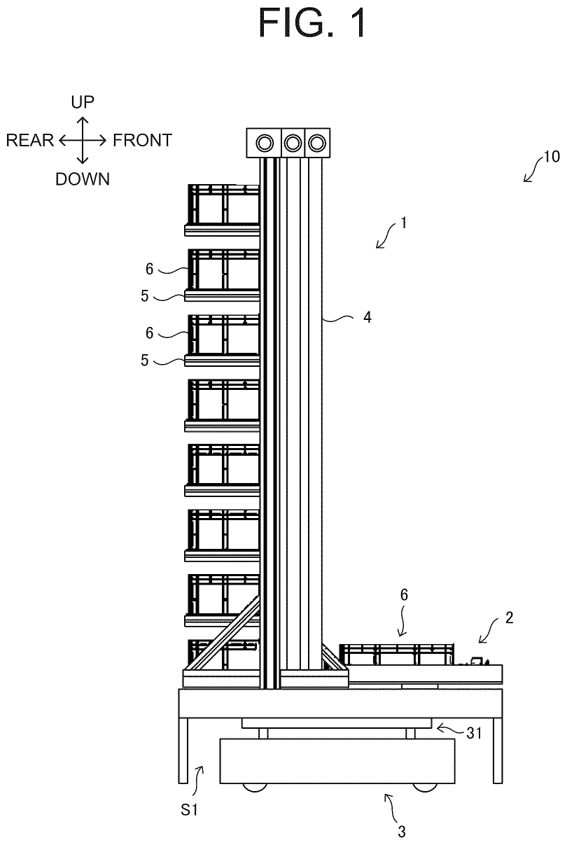

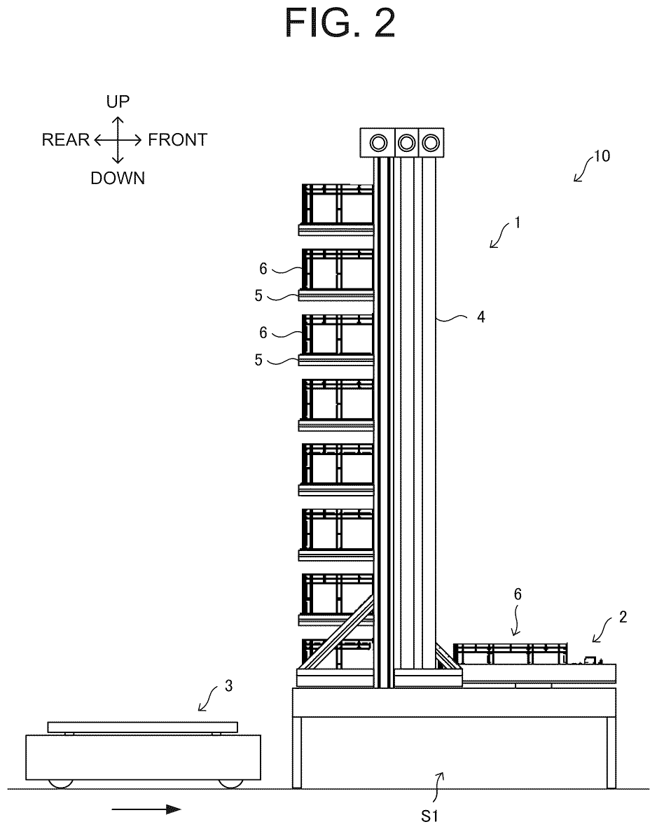

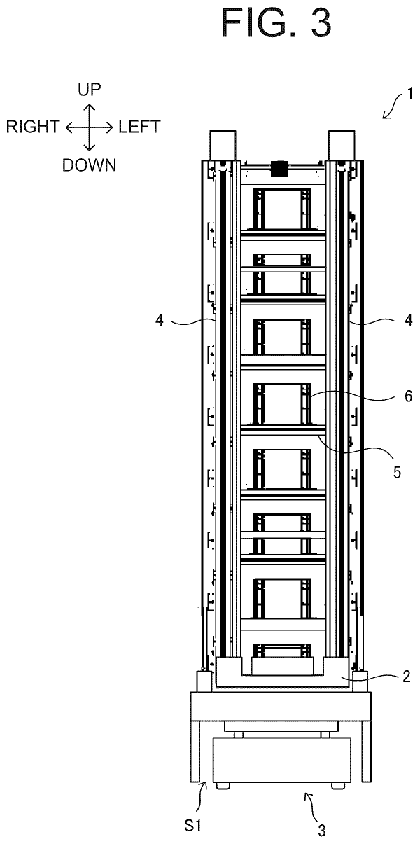

FIGS. 1 and 2 are side views illustrating an overall configuration of an automatic transport system 10 according to an embodiment of the present disclosure, and FIG. 3 is a front view illustrating an overall configuration of the automatic transport system 10. The automatic transport system 10 includes a storage shelf 1, and an automatic transport device 3 capable of transporting the storage shelf 1 in a state of being coupled to the storage shelf 1. FIG. 1 illustrates a state (coupled state) in which the storage shelf 1 and the automatic transport device 3 are connected to each other, and FIG. 2 illustrates a state (un-coupled state) in which the storage shelf 1 and the automatic transport device 3 are not connected to each other.

The storage shelf 1 includes a stock shelf 5 (storage) that stores a transport object 6, and a transfer device 2 (driver) provided adjacent to the stock shelf 5 for taking in and out (inbound and outbound delivery of) the transport object 6 with respect to the stock shelf 5. The stock shelf 5 is an accommodation shelf capable of accommodating the transport object 6, and is constituted of a plurality of (eight in FIG. 1) accommodation shelves. The transfer device 2 can move up and down on a front surface of the storage shelf 1, and takes out the transport object 6 from the stock shelf 5 for discharging (outbound delivery) to the outside, or accommodates (performs inbound delivery of) the transport object 6 taken out from the outside in the stock shelf 5.

The automatic transport device 3 is a transport vehicle (automatic guided vehicle) capable of unmanned traveling. The automatic transport device 3 is configured to be capable of forward traveling, backward traveling, and turning traveling. The storage shelf 1 has a space S1 below into which the automatic transport device 3 can enter. The automatic transport device 3 is configured to be couplable to the storage shelf 1 when entering the space S1. The automatic transport device 3 can travel in a state of being coupled to the storage shelf 1. For example, the automatic transport device 3 travels in a state (coupled state) in which the automatic transport device 3 slips under the storage shelf 1 and lifts the storage shelf 1. Thus, the automatic transport device 3 can move the storage shelf 1 to a target position.

Specifically, the automatic transport device 3 moves to the position of the target storage shelf 1, based on, for example, a transport request received by a server (not illustrated), and moves the storage shelf 1 to the target position when the automatic transport device 3 slips under the storage shelf 1 and is coupled to the storage shelf 1 (see FIG. 2). Based on the transport request, the automatic transport device 3 autonomously travels along a preset travel route, and moves the storage shelf 1 to the target position (outbound location or the like). The storage shelf 1 picks the transport object 6 at the target position for inbound and outbound delivery.

Note that, the traveling method of the automatic transport device 3 is not particularly limited, and a traveling method such as guide traveling in which the automatic transport device 3 travels while detecting a magnetic tape installed on a floor surface, guideless traveling in which the automatic transport device 3 travels along a travel route while estimating its own position, or a two dimensional code method in which the automatic transport device 3 travels while performing fixed point correction using a two dimensional code installed on a floor surface can be applied.

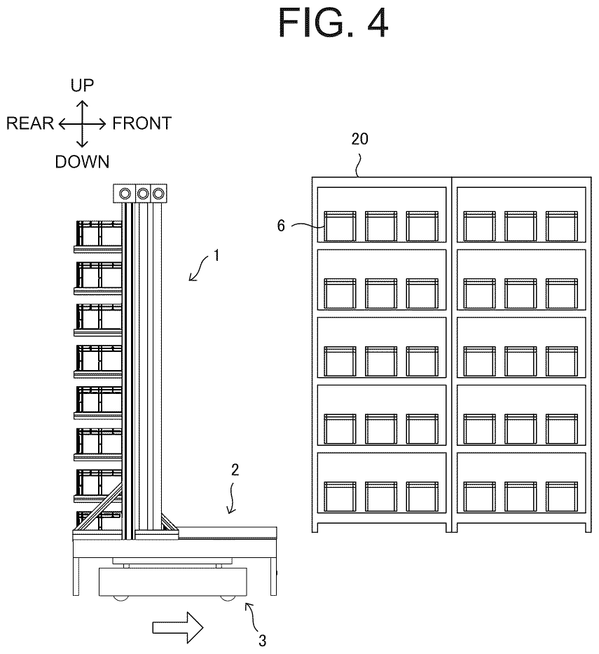

As illustrated in FIG. 1, the storage shelf 1 includes the stock shelf 5, and the transfer device 2 movable up and down. Specifically, the storage shelf 1 is provided with an elevating device 4, and the elevating device 4 can move the transfer device 2 to a predetermined height by controlling the transfer device 2 to move up and down. Although not illustrated, the elevating device 4 includes an elevating rail, an elevating motor, and the like. When acquiring a transport request for the transport object 6, the elevating device 4 moves (raises or lowers) the transfer device 2 to the height of a storage shelf 20 (see FIG. 4) in which the transport object 6 is stored.

The transfer device 2 picks the target transport object 6 from the storage shelf 20 (see FIG. 4) in which the transport object 6 is stored, and stocks (moves) the transport object 6 in the stock shelf 5.

Herein, an example of a procedure of moving the transport object 6 to the stock shelf 5 is described. FIG. 4 illustrates the storage shelf 20 in which the transport object 6 is stored. When the automatic transport device 3 acquires a transport request (picking command) for the transport object 6, the automatic transport device 3 travels to the position of the storage shelf 1, enters the space S1 under the storage shelf 1 to be coupled thereto, and thereafter, travels along a preset travel route to the front of the storage shelf 20 in which the transport object 6 is stored (see FIG. 4).

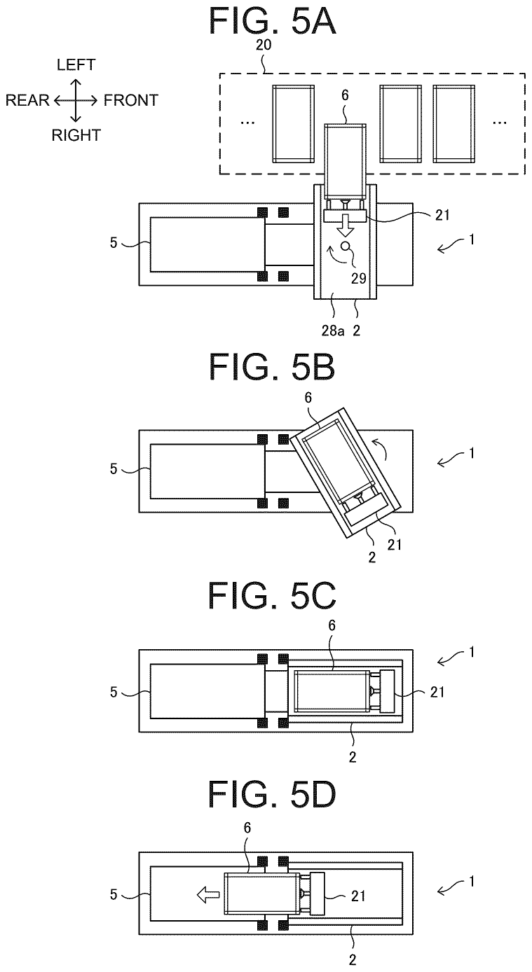

FIGS. 5A to 5D schematically illustrate a procedure in which the transfer device 2 picks the transport object 6 from the storage shelf 20 and moves to the stock shelf 5, as viewed from above. First, when the automatic transport device 3 arrives in front of the storage shelf 20 and stops, the transfer device 2 moves (moves up and down) to the position of the shelf in which the target transport object 6 is stored in accordance with an instruction of the elevating device 4. The elevating device 4 acquires position information of the transport object 6, based on identification information of the transport object 6 included in the transport request, and moves the transfer device 2 to the target position, based on the position information. When arriving at the target position (height), the transfer device 2 rotates in a predetermined direction (for example, clockwise) about a rotation shaft 29. For example, when the automatic transport device 3 is stopped alongside the storage shelf 20, as illustrated in FIG. 5A, the transfer device 2 rotates clockwise by 90 degrees about the rotation shaft 29.

Next, the transfer device 2 moves a connector 21 toward the storage shelf 20 (in the left direction in FIGS. 5A to 5D) to connect the connector 21 to a side surface of the transport object 6. When the connector 21 is connected to the side surface of the transport object 6, the transfer device 2 moves the connector 21 in a direction (the right direction in FIGS. 5A to 5D) opposite to the storage shelf 20, thereby sliding the transport object 6 on a slide surface 28a of the transfer device 2 and placing the transport object 6 on the slide surface 28a (see FIG. 5B).

Next, the transfer device 2 rotates by 90 degrees in a predetermined direction (counterclockwise) about the rotation shaft 29 (see FIGS. 5B and 5C). Next, the transfer device 2 moves (moves up and down) to a target stock position (empty space) of the stock shelf 5 in accordance with an instruction of the elevating device 4. When the transfer device 2 arrives at the target position (height), the transfer device 2 slides the transport object 6 on the slide surface 28a and pushes the transport object 6 into the stock shelf 5 by moving the connector 21 in the direction (the rearward direction in FIGS. 5A to 5D) of the stock shelf 5 (see FIG. 5D). In this way, the transfer device 2 picks the transport object 6 from the storage shelf 20 and moves the transport object 6 to the stock shelf 5.

When picking the transport object 6 stocked on the stock shelf 5, the transfer device 2 performs a procedure reverse to the above-described procedure.

In this way, the storage shelf 1 can perform inbound and outbound delivery work (picking) of the transport object 6 with respect to the stock shelf 5 by controlling the operation of the transfer device 2. Further, the storage shelf 1 performs a picking operation by driving the transfer device 2 by electric power supplied from the automatic transport device 3.

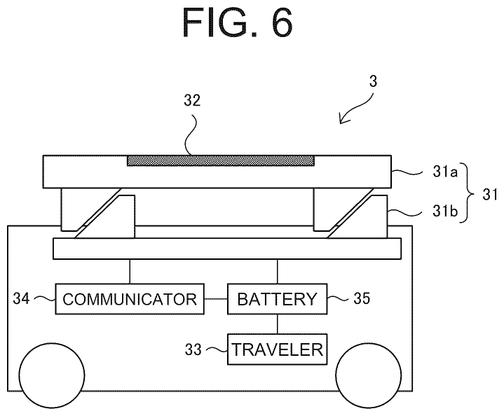

Next, a specific configuration of the storage shelf 1 and the automatic transport device 3 is described with reference to FIGS. 6 to 8.

The automatic transport device 3 includes a coupler 31 couplable to the storage shelf 1, and switchable between a coupled state in which the coupler 31 is coupled to the storage shelf 1 and a non-coupled state in which the coupler 31 is not coupled to the storage shelf 1, an electric power supply terminal 32 that supplies electric power to the transfer device 2 (driver) via the coupler 31 when the coupler 31 is in the coupled state, and a traveler 33 that causes the automatic transport device 3 to travel. In addition, the automatic transport device 3 includes a communicator 34 that transmits a control signal to the transfer device 2 of the storage shelf 1. Further, the automatic transport device 3 includes a battery 35 (electric power supplier) that supplies electric power to the traveler 33 and the communicator 34. The battery 35 is charged with electric power from, for example, an external power supply (see FIG. 6).

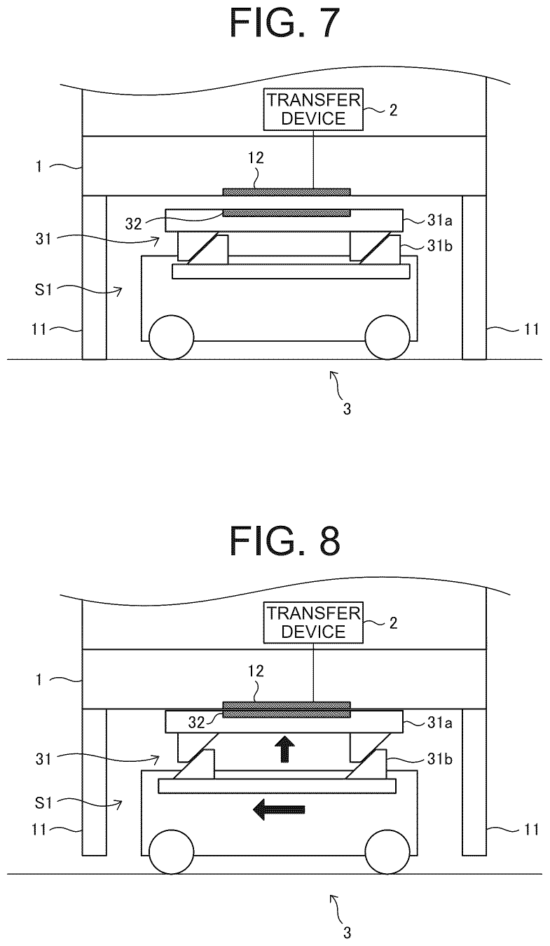

The storage shelf 1 includes legs 11 (see FIG. 7) that come into contact with the floor surface, and the space S1 into which the automatic transport device 3 can enter is provided between a bottom surface of the storage shelf 1 and a floor surface. Further, an electric power receiving terminal 12 that receives electric power supplied from the outside is provided on the bottom surface of the storage shelf 1, and the electric power receiving terminal 12 is connected to the transfer device 2.

The traveler 33 of the automatic transport device 3 causes the automatic transport device 3 to enter the space S1 below the storage shelf 1, and the coupler 31 lifts the storage shelf 1 and couples the storage shelf 1 by moving upward from an upper surface of the automatic transport device 3 (see FIG. 7).

Specifically, the coupler 31 is provided on the upper surface of the automatic transport device 3, and includes an upper coupling portion 31a, a lower coupling portion 31b, and the electric power supply terminal 32. The coupler 31 is driven by electric power of the battery 35. For example, when the automatic transport device 3 enters the space S1 below the storage shelf 1, the coupler 31 moves the lower coupling portion 31b in the left direction (the direction of the arrow in FIG. 8).

Herein, each of the upper coupling portion 31a and the lower coupling portion 31b has an inclined surface, and is arranged in such a way that the inclined surfaces come into contact with each other. The upper coupling portion 31a is configured to be movable up and down relative to the lower coupling portion 31b in accordance with movement of the lower coupling portion 31b in a lateral direction. With the above configuration, for example, when the lower coupling portion 31b is moved in the left direction (in the direction of the arrow in FIG. 8), the upper coupling portion 31a is moved upward (see FIG. 8). Further, when the lower coupling portion 31b is moved in the right direction in the state illustrated in FIG. 8, the upper coupling portion 31a is moved downward (see FIG. 7).

After the coupler 31 raises the upper coupling portion 31a to come into contact with the bottom surface of the storage shelf 1, the coupler 31 further raises the upper coupling portion 31a until the storage shelf 1 is lifted upward from the floor surface (until the legs 11 leave the floor surface).

The electric power supply terminal 32 is provided on an upper surface of the upper coupling portion 31a, and the electric power receiving terminal 12 is provided on the bottom surface of the storage shelf 1. Therefore, when the upper coupling portion 31a comes into contact with the bottom surface of the storage shelf 1, the electric power supply terminal 32 and the electric power receiving terminal 12 are electrically connected. Accordingly, electric power is supplied from the battery 35 of the automatic transport device 3 to the electric power receiving terminal 12 via the electric power supply terminal 32. Further, since the electric power receiving terminal 12 is connected to the transfer device 2, electric power is supplied from the battery 35 of the automatic transport device 3 to the transfer device 2 via the electric power receiving terminal 12.

In this way, the coupler 31 of the automatic transport device 3 is configured to be switchable between a coupled state (see FIG. 8) in which the coupler 31 is coupled to the storage shelf 1 and a non-coupled state (see FIG. 7) in which the coupler 31 is not coupled to the storage shelf 1. In addition, the battery 35 supplies electric power to the transfer device 2 of the storage shelf 1 via the coupler 31 when the coupler 31 is in the coupled state. Specifically, the battery 35 supplies electric power to the transfer device 2 when the coupler 31 (upper coupling portion 31a) rises and the electric power supply terminal 32 is connected to the electric power receiving terminal 12 of the storage shelf 1.

In the case of the coupled state, the traveler 33 causes the automatic transport device 3 to travel in a state in which the coupler 31 lifts the storage shelf 1. Accordingly, the automatic transport device 3 can automatically travel to the target position in a state in which the storage shelf 1 is lifted. In this way, according to the automatic transport system 10, the automatic transport device 3 can move the storage shelf 1 having the driver (transfer device 2) capable of taking in and out the transport object to any place. For example, the automatic transport device 3 can change the arrangement layout of the plurality of storage shelves 1, and each storage shelf 1 can take in and out the transport object 6 in the changed arrangement layout. Therefore, a flexible operation can be performed in a system for transporting the transport object 6 by the automatic transport device 3.

Note that, a configuration (lift-up mechanism) in which the automatic transport device 3 lifts the storage shelf 1 is not limited to the above-described configuration. For example, in the automatic transfer device 3, a central support column (not illustrated) may expand and contract, or move in such a way that a top plate including the electric power supply terminal 32 can be raised and lowered.

Further, in the case of the coupled state, the communicator 34 transmits, to the storage shelf 1 via the electric power supply terminal 32, a control signal for raising and lowering the transfer device 2, and a control signal for causing the transfer device 2 to take in and out the transport object 6. The transfer device 2 takes in and out the transport object 6 on the stock shelf 5 in the coupled state. For example, based on the control signal acquired from the automatic transport device 3, the transfer device 2 performs outbound delivery of a target transport object 6 from the stock shelf 5, or performs inbound delivery of a transport object 6 received from the external storage shelf 20 (see FIG. 4) to a target position of the stock shelf 5.

Note that, the transfer device 2 may perform transfer (inbound and outbound delivery) of the transport object 6 between the stock shelf 5 and the external storage shelf 20 (see FIG. 4), or may perform transfer (inbound and outbound delivery) of the transport object 6 between the transfer device 2 and a conveyor line (not illustrated).

In the above-described embodiment, the transfer device 2 is configured to be driven by electric power supplied from the automatic transport device 3. However, as another embodiment, the storage shelf 1 may include a battery, and the transfer device 2 may be configured to be driven by electric power supplied from the battery of the storage shelf 1. The battery of the storage shelf 1 may be charged by electric power supplied from the automatic transport device 3, or may be charged from an external power supply. According to the configuration in which the transfer device 2 is driven by electric power of the battery of the storage shelf 1, even in a state (non-coupled state) in which the automatic transport device 3 is not connected to the storage shelf 1, the transfer device 2 can perform inbound and outbound delivery work.

### SUPPLEMENTARY NOTES OF DISCLOSURE

Hereinafter, a summary of the disclosure extracted from the above-described embodiment is added. Note that, each configuration and each processing function described in the following supplementary notes can be selected and combined in any way.

### Supplementary Note 1

An automatic transport system including a storage shelf, and an automatic transport device capable of transporting the storage shelf in a state of being coupled to the storage shelf, wherein
the storage shelf includes a storage that stores a transport object, and a driver that takes in and out the transport object in the storage, and
the automatic transport device includes
a coupler couplable to the storage shelf, and switchable between a coupled state in which the coupler is coupled to the storage shelf and a non-coupled state in which the coupler is not coupled to the storage shelf,
an electric power supplier that supplies electric power to the driver via the coupler when the coupler is in the coupled state, and
a traveler that causes the automatic transport device to travel.

### Supplementary Note 2

The automatic transport system according to Supplementary Note 1, wherein
the storage shelf includes legs that come into contact with a floor surface, and has a space between a bottom surface of the storage shelf and the floor surface into which the automatic transport device can enter.

### Supplementary Note b 3

The automatic transport system according to Supplementary Note 1 or 2, wherein
the traveler causes the automatic transport device to enter below the storage shelf, and
the coupler lifts and couples the storage shelf by moving upward from an upper surface of the automatic transport device.

### Supplementary Note 4

The automatic transport system according to Supplementary Note 3, wherein
the traveler causes the automatic transport device to travel in a state in which the coupler lifts the storage shelf.

### Supplementary Note 5

The automatic transport system according to Supplementary Note 3 or 4, wherein
the coupler includes an electric power supply terminal, and
the electric power supplier supplies electric power to the driver when the coupler is raised and the electric power supply terminal is connected to the storage shelf.

### Supplementary Note 6

The automatic transport system according to Supplementary Note 5, further including a communicator that transmits a control signal to the driver, wherein
the communicator transmits, to the storage shelf via the electric power supply terminal, a control signal for raising and lowering the driver, and a control signal for causing the driver to take in and out the transport object.

### Supplementary Note 7

The automatic transport system according to any one of Supplementary Notes 1 to 6, wherein
the driver takes in and out the transport object in the storage in a state in which the coupler is coupled to the storage shelf.

### Supplementary Note 8

The automatic transport system according to any one of Supplementary Notes 1 to 7, wherein
the driver transfers the transport object between the storage and an external conveyor line.

### Supplementary Note 9

The Automatic Transport System According to Any One of Supplementary Notes 1 to 8, wherein
the storage is capable of storing a plurality of the transport objects, and
the driver is a transfer device provided adjacent to the storage.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An automatic transport system comprising a storage shelf, and an automatic transport device capable of transporting the storage shelf in a state of being coupled to the storage shelf, wherein
the storage shelf includes a storage that stores a transport object, and a driver that takes in and out the transport object in the storage, and
the automatic transport device includes
a coupler couplable to the storage shelf, and switchable between a coupled state in which the coupler is coupled to the storage shelf and a non-coupled state in which the coupler is not coupled to the storage shelf,
an electric power supplier that supplies electric power to the driver via the coupler when the coupler is in the coupled state, and
a traveler that causes the automatic transport device to travel.

2. The automatic transport system according to claim 1, wherein
the storage shelf includes legs that come into contact with a floor surface, and has a space between a bottom surface of the storage shelf and the floor surface into which the automatic transport device can enter.

3. The automatic transport system according to claim 1, wherein
the traveler causes the automatic transport device to enter below the storage shelf, and
the coupler lifts and couples the storage shelf by moving upward from an upper surface of the automatic transport device.

4. The automatic transport system according to claim 3, wherein
the traveler causes the automatic transport device to travel in a state in which the coupler lifts the storage shelf.

5. The automatic transport system according to claim 3, wherein
the coupler includes an electric power supply terminal, and
the electric power supplier supplies electric power to the driver when the coupler is raised and the electric power supply terminal is connected to the storage shelf.

6. The automatic transport system according to claim 5, further comprising a communicator that transmits a control signal to the driver, wherein
the communicator transmits, to the storage shelf via the electric power supply terminal, a control signal for raising and lowering the driver, and a control signal for causing the driver to take in and out the transport object.

7. The automatic transport system according to claim 1, wherein
the driver takes in and out the transport object in the storage in a state in which the coupler is coupled to the storage shelf.

8. The automatic transport system according to claim 1, wherein
the driver transfers the transport object between the storage and an external conveyor line.

9. The automatic transport system according to claim 1, wherein
the storage is capable of storing a plurality of the transport objects, and
the driver is a transfer device provided adjacent to the storage.
